(19) United States
(12) Patent Application Publication
(10) Pub. No.: US 2026/0331705 A1
(43) Pub. Date: Oct. 22, 2026

(54) ELECTRODE ASSEMBLY

(71) Applicant: TOYOTA JIDOSHA KABUSHIKI KAISHA, Toyota-shi (JP)

(72) Inventors: Takahiko NAKANO, Nagoya-shi (JP); Yosuke SHIMURA, Nagakute-shi (JP); Yasuhiro SAKASHITA, Nisshin-Shi (JP); Suguru IKEYAMA, Toyota-shi (JP); Tomofumi HIRUKAWA, Miyoshi-shi (JP); Kazuhito KATO, Toyota-shi (JP)

(73) Assignee: TOYOTA JIDOSHA KABUSHIKI KAISHA, Toyota-shi (JP)

(21) Appl. No.: 19/529,601

(22) Filed: Feb. 4, 2026

(30) Foreign Application Priority Data
Apr. 18, 2025 (JP) 2025-068818

(51) Int. Cl. H01M 50/466; H01M 10/04; H01M 50/46

(52) U.S. Cl. CPC H01M 50/466; H01M 10/0459; H01M 50/461

(57) ABSTRACT

An electrode assembly includes a plurality of electrode laminates stacked along a first direction. Each of the electrode laminates includes a plurality of electrode sheets stacked along the first direction, and a long separator extending in a zigzag pattern between the electrode sheets. A binding portion that surrounds the electrode laminates together is provided integrally with the separator of one of the electrode laminates.

### CROSS-REFERENCE TO RELATED APPLICATION

This application claims priority to Japanese Patent Application No. 2025-068818 filed on Apr. 18, 2025. The disclosure of the above-identified application, including the specification, drawings, and claims, is incorporated by reference herein in its entirety.

### BACKGROUND

### 1. Technical Field

The technology disclosed in the present specification relates to an electrode assembly.

### 2. Description of Related Art

An electrode assembly is described in Japanese Unexamined Patent Application Publication No. 2007-305464 (JP 2007-305464 A). The electrode assembly includes a plurality of stacked electrode laminates. Each of the electrode laminates includes a plurality of stacked electrode sheets and a long separator extending in a zigzag pattern between the electrode sheets.

In the electrode assembly described above, the electrode sheets are stacked one by one while the separator is folded in the zigzag pattern. At this time, deviations may occur in the positions where the separator is folded. Therefore, when the separator is repeatedly folded in the zigzag pattern, the deviations accumulate, which may cause non-negligible deviations in the stacking positions of the electrode sheets. In this regard, when the electrode assembly is divided into the electrode laminates and the separators between the electrode laminates are independent of each other as described in JP 2007-305464 A, the accumulation of the above deviations can be suppressed.

### SUMMARY

When the electrode assembly is divided into the electrode laminates, however, there is a possibility of unintended positional displacement between the electrode laminates because no binding force is generated between the electrode laminates. In view of the above, the present specification provides a technology that can improve the manufacturing quality of an electrode assembly that employs a zigzag separator.

The technology disclosed in the present specification is embodied in an electrode assembly. In a first aspect, the electrode assembly includes a plurality of electrode laminates stacked along a first direction. Each of the electrode laminates includes a plurality of electrode sheets stacked along the first direction, and a long separator extending in a zigzag pattern between the electrode sheets. A binding portion that surrounds the electrode laminates together is provided integrally with the separator of one of the electrode laminates.

In the electrode assembly described above, the binding portion is provided integrally with the separator of one of the electrode laminates. The binding portion surrounds the electrode laminates together, thereby generating a binding force between the electrode laminates, and suppressing positional displacement between the electrode laminates. In each of the electrode laminates, the binding force of the binding portion suppresses positional displacement between the electrode sheets. Therefore, it is only necessary to provide the binding portion to the separator of at least one of the electrode laminates. Thus, it is possible to suppress complication of the configuration of the electrode assembly.

In a second aspect, in the first aspect, in two adjacent electrode laminates out of the plurality of electrode laminates, a distance between centers of gravity in a second direction orthogonal to the first direction may be equal to or less than a predetermined reference value. In other words, when stacking the electrode laminates in the manufacture of the electrode assembly, it is appropriate to adjust the stacking positions based on the centers of gravity of the electrode laminates. Thus, the electrode laminates can be stacked accurately.

In a third aspect, in the first or second aspect, the separators of two adjacent electrode laminates out of the plurality of electrode laminates may be joined to each other. With this configuration, the positional displacement between the two adjacent electrode laminates is suppressed.

In a fourth aspect, in any one of the first to third aspects, the binding portion provided integrally with the separator may make at least one loop around the electrode laminates, and a tip of the binding portion may be joined to the binding portion. With this configuration, the binding portion has a ring-shaped structure that makes a loop around the electrode laminates. Thus, the binding force on the electrode laminates can be increased.

In a fifth aspect, in any one of the first to fourth aspects, the separators of two adjacent electrode laminates out of the plurality of electrode laminates may be directly adjacent to each other. That is, the electrode sheet need not be disposed between the two adjacent electrode laminates out of the plurality of electrode laminates.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a battery 100;

FIG. 2 is a diagram illustrating that an electrode assembly 10 is housed in an exterior member 102;

FIG. 3 is a diagram schematically showing the configuration of the electrode assembly 10 according to an embodiment;

FIG. 4A is an enlarged view of part IV(A) in FIG. 3; and

FIG. 4B is an enlarged view of part IV(B) in FIG. 3.

### DETAILED DESCRIPTION OF EMBODIMENTS

An electrode assembly 10 according to an embodiment and a battery 100 that employs the electrode assembly 10 will be described with reference to the drawings. The battery 100 is, for example, a lithium-ion secondary battery. The battery 100 has a rectangular flat plate shape. Hereinafter, the thickness direction of the battery 100 is referred to as a Z-direction, the longitudinal direction of the battery 100 is referred to as an X-direction, and the direction orthogonal to both the Z-direction and the X-direction is referred to as a Y-direction.

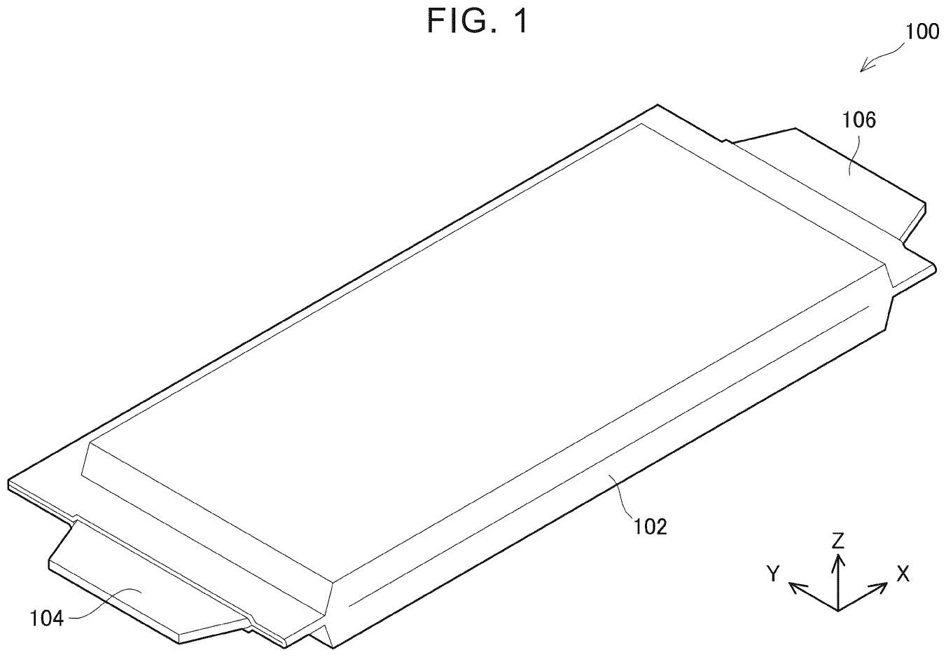

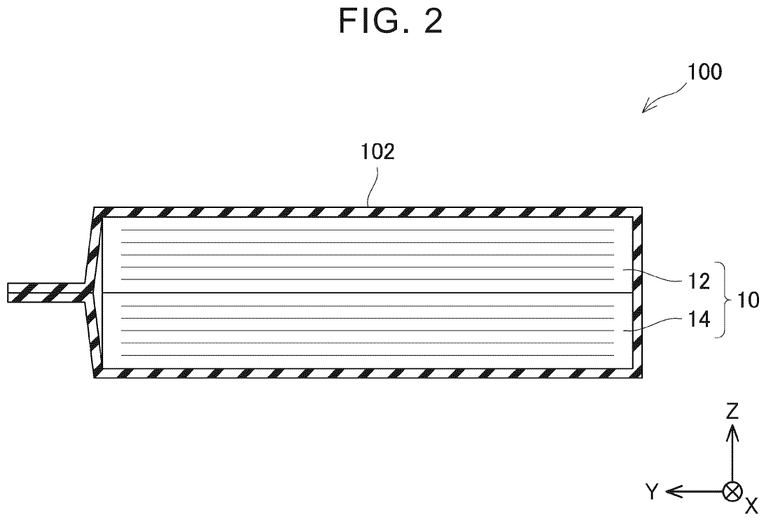

As shown in FIGS. 1 and 2, the battery 100 includes an exterior member 102. The electrode assembly 10 is sealed in the exterior member 102 together with an electrolytic solution (not shown). The exterior member 102 is made of a thin film. The exterior member 102 is, for example, a laminate film in which resin coating films are provided on both surfaces of an aluminum foil.

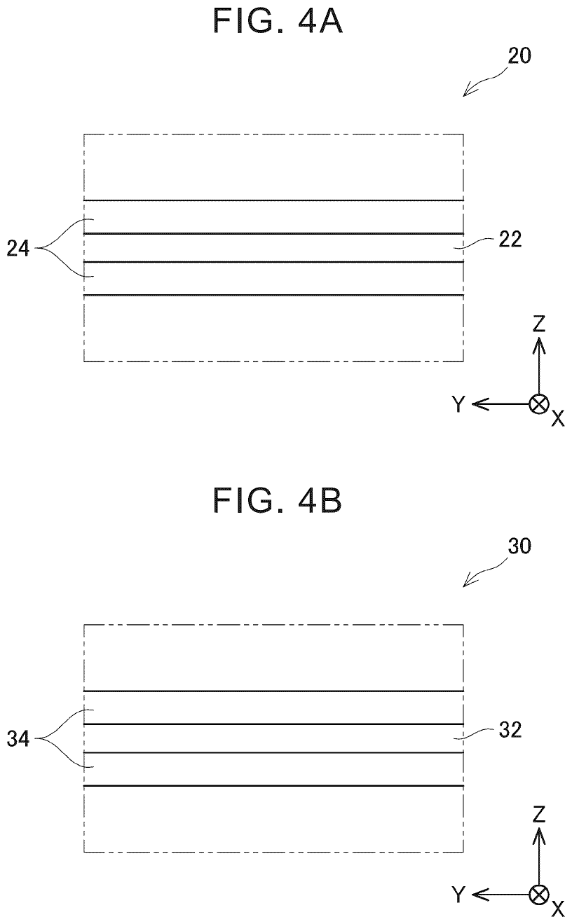

As shown in FIG. 1, the battery 100 further includes a cathode terminal 104 and an anode terminal 106. One end of the cathode terminal 104 is exposed to the outside of the exterior member 102, and the other end of the cathode terminal 104 is connected to each cathode current collecting foil 22 of the electrode assembly 10 inside the exterior member 102 (see FIG. 4A). One end of the anode terminal 106 is exposed to the outside of the exterior member 102, and the other end of the anode terminal 106 is connected to each anode current collecting foil 32 of the electrode assembly 10 inside the exterior member 102 (see FIG. 4B). The other end of the cathode terminal 104 may be connected to each cathode current collecting foil 22 via a tab provided integrally with each cathode current collecting foil 22, or may be connected to each cathode current collecting foil 22 via a tab joined to each cathode current collecting foil 22 by welding etc. Similarly, the other end of the anode terminal 106 may be connected to each anode current collecting foil 32 via a tab provided integrally with each anode current collecting foil 32, or may be connected to each anode current collecting foil 32 via a tab joined to each anode current collecting foil 32 by welding etc.

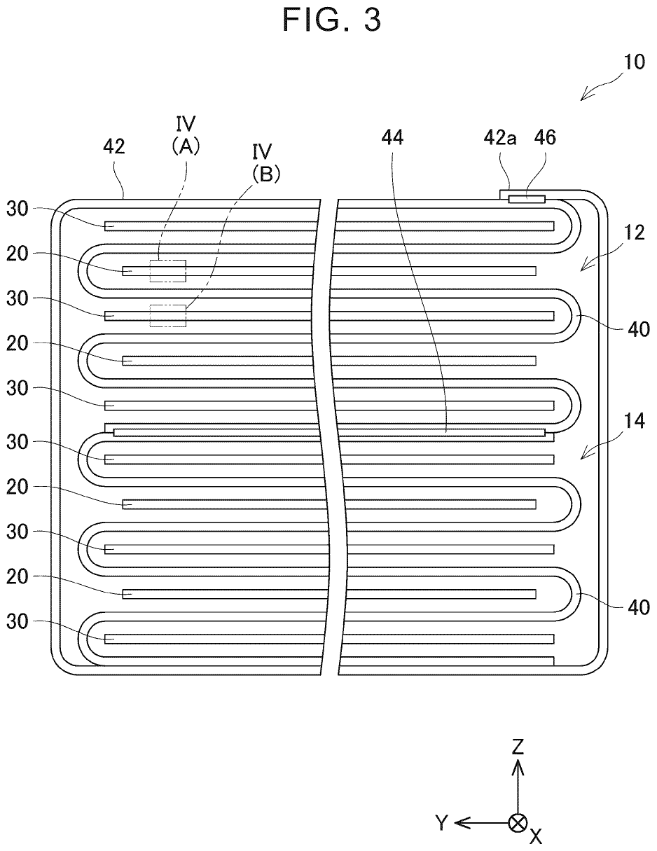

As shown in FIGS. 2 and 3, the electrode assembly 10 includes two electrode laminates 12, 14. The two electrode laminates 12, 14 are stacked along the Z-direction. That is, the Z-direction coincides with the stacking direction of the two electrode laminates 12, 14. The two electrode laminates 12, 14 include a first electrode laminate 12 and a second electrode laminate 14. The second electrode laminate 14 is disposed on one side of the first electrode laminate 12 in the Z-direction (here, the −Z-direction).

As shown in FIG. 3, each of the electrode laminates 12, 14 includes a plurality of electrode sheets 20, 30 and a separator 40. The electrode sheets 20, 30 are stacked along the Z-direction. Each of the electrode sheets 20, 30 has a rectangular shape when viewed along the Z-direction. The electrode sheets 20, 30 include a plurality of cathode sheets 20 and a plurality of anode sheets 30. The separator 40 is a long sheet. The separator 40 extends in a zigzag pattern between the cathode sheets 20 and the anode sheets 30. That is, the separator 40 is folded by alternately repeating mountain folds and valley folds at predetermined intervals. Between the folds of the separator 40, the cathode sheets 20 and the anode sheets 30 are alternately stacked one by one. The number of electrode sheets 20, 30 included in each of the electrode laminates 12, 14 is not particularly limited.

As shown in FIG. 4A, each of the cathode sheets 20 includes the cathode current collecting foil 22 and cathode active material layers 24. Each of the cathode current collecting foil 22 and the cathode active material layer 24 has a rectangular shape when viewed along the Z-direction. The cathode current collecting foil 22 is, for example, an aluminum foil. The cathode active material layers 24 are provided on both surfaces of the cathode current collecting foil 22. The cathode active material layer 24 contains a cathode active material. Examples of cathode active materials include lithium nickel composite oxides, lithium cobalt composite oxides, and lithium manganese composite oxides. The cathode active material may be formed of a single material or of multiple materials. The cathode active material layer 24 may further contain a binder, a conductive aid, etc. The cathode active material layers 24 need not be provided on both surfaces of the cathode current collecting foil 22. That is, in another embodiment, the cathode active material layer 24 may be provided on one surface of the cathode current collecting foil 22.

As shown in FIG. 4B, each of the anode sheets 30 includes the anode current collecting foil 32 and anode active material layers 34. Each of the anode current collecting foil 32 and the anode active material layer 34 has a rectangular shape when viewed along the Z-direction. The anode current collecting foil 32 is, for example, a copper foil. The anode active material layers 34 are provided on both surfaces of the anode current collecting foil 32. The anode active material layer 34 contains an anode active material. Examples of anode active materials include carbon materials such as graphite, hard carbon, and soft carbon; materials such as silicon (Si) that form alloys with lithium; and lithium alloys. The anode active material may be formed of a single material or of multiple materials. The anode active material layer 34 may further contain a binder etc. The anode active material layers 34 need not be provided on both surfaces of the anode current collecting foil 32. That is, in another embodiment, the anode active material layer 34 may be provided on one surface of the anode current collecting foil 32.

The separator 40 is configured such that charge carriers (lithium ions in this case) can pass therethrough. The separator 40 is made of an insulating material such as polypropylene or polyethylene. The separator 40 may be, for example, a porous polyethylene film or a porous polypropylene film.

As shown in FIG. 3, the separators 40 of the two electrode laminates 12, 14 are directly adjacent to each other. That is, the electrode sheets 20, 30 are not disposed between the two electrode laminates 12, 14. The separators 40 of the two electrode laminates 12, 14 are joined to each other via a first joining portion 44. In the two electrode laminates 12, 14, the dimensions of the directly adjacent separators 40 in the Y-direction may be equal to or different from each other.

In the two electrode laminates 12, 14, the distance between the centers of gravity in the X-direction is equal to or less than a predetermined reference value. The predetermined reference value is, for example, 20% or less of the dimension of each of the active material layers 24, 34 of the electrode sheets 20, 30 in the X-direction, or is, for example, 10% or less of the dimension of each of the active material layers 24, 34 of the electrode sheets 20, 30 in the X-direction. In the two electrode laminates 12, 14, the distance between the centers of gravity in the Y-direction is equal to or less than a predetermined reference value. The predetermined reference value is, for example, 20% or less of the dimension of each of the active material layers 24, 34 of the electrode sheets 20, 30 in the Y-direction, or is, for example, 10% or less of the dimension of each of the active material layers 24, 34 of the electrode sheets 20, 30 in the Y-direction.

As shown in FIG. 3, the separator 40 of the first electrode laminate 12 includes a binding portion 42. The binding portion 42 is provided integrally with the separator 40. The binding portion 42 is made of the same material as that of the separator 40. The binding portion 42 surrounds the two electrode laminates 12, 14 together. In the present embodiment, the binding portion 42 makes a loop around the two electrode laminates 12, 14, and a tip 42a of the binding portion 42 is joined to the binding portion 42 via a second joining portion 46 at the end face of the first electrode laminate 12 in the Z-direction (end face in a +Z-direction in this case).

In the electrode assembly 10 described above, the binding portion 42 is provided integrally with the separator 40 of the first electrode laminate 12. The binding portion 42 surrounds the two electrode laminates 12, 14 together, thereby generating a binding force between the two electrode laminates 12, 14, and suppressing positional displacement between the two electrode laminates 12, 14. In each of the electrode laminates 12, 14, the binding force of the binding portion 42 suppresses positional displacement between the electrode sheets 20, 30. Therefore, it is only necessary to provide the binding portion 42 to the separator 40 of at least one of the electrode laminates 12, 14. Thus, it is possible to suppress complication of the configuration of the electrode assembly 10.

In the above embodiment, the distance between the centers of gravity of the two adjacent electrode laminates 12, 14 in the X-direction is equal to or less than the predetermined reference value. The distance between the centers of gravity of the two adjacent electrode laminates 12, 14 in the Y-direction is equal to or less than the predetermined reference value. In other words, when stacking the electrode laminates 12, 14 in the manufacture of the electrode assembly 10, it is appropriate to adjust the stacking positions based on the centers of gravity of the electrode laminates 12, 14. Alternatively, for example, it is conceivable to stack the electrode laminates 12, 14 based on the tabs provided to the electrode laminates 12, 14. In this case, the positions of the tabs are shifted as the stacking positions of the electrode sheets 20, 30 are shifted. Therefore, the electrode laminates 12, 14 can be accurately stacked by stacking the electrode laminates 12, 14 based on the centers of gravity of the electrode laminates 12, 14 as described above.

In the above embodiment, the separators 40 of the two adjacent electrode laminates 12, 14 are joined to each other via the first joining portion 44. With this configuration, the positional displacement between the two adjacent electrode laminates 12, 14 is suppressed. The method for joining the separator 40 of the first electrode laminate 12 and the separator 40 of the second electrode laminate 14 is not particularly limited. For example, in some embodiments, the first joining portion 44 may be made of an adhesive material such as glue or adhesive tape. Alternatively, the first joining portion 44 may be a welded portion where the separators 40 are thermally welded. In other embodiments, the separators 40 of the two adjacent electrode laminates 12, 14 need not be joined to each other.

In the above embodiment, the binding portion 42 provided integrally with the separator 40 makes at least one loop around the two electrode laminates 12, 14, and the tip 42a of the binding portion 42 is joined to the binding portion 42 via the second joining portion 46. With this configuration, the binding portion 42 makes the loop to surround the two electrode laminates 12, 14, thereby generating a binding force between the two electrode laminates 12, 14. The method for joining the tip 42a of the binding portion 42 to the binding portion 42 is not particularly limited. For example, in some embodiments, the second joining portion 46 may be made of an adhesive material such as glue or adhesive tape. Alternatively, the second joining portion 46 may be a welded portion where the binding portion 42 is thermally welded.

In the above embodiment, the tip 42a of the binding portion 42 is joined to the binding portion 42 via the second joining portion 46 at the end face of the first electrode laminate 12 in the Z-direction (i.e., the end face in the +Z-direction). Alternatively, the tip 42a of the binding portion 42 may be joined to the binding portion 42 via the second joining portion 46 at the end face of the second electrode laminate 14 in the Z-direction (i.e., the end face in the −Z-direction). In this case, it is appropriate that the binding portion 42 make a loop around the two electrode laminates 12, 14. For example, when the second joining portion 46 is the welded portion where the binding portion 42 is thermally welded, the tip 42a may be pressed against the binding portion 42 by a heated member. In this case, the tip 42a can be more firmly joined to the binding portion 42 when the tip 42a is pressed against the binding portion 42 along the Z-direction (i.e., the stacking direction of the electrode laminates 12, 14) than when the tip 42a is pressed against the binding portion 42 along the Y-direction.

Instead of the above, the tip 42a of the binding portion 42 may be joined to the binding portion 42 via the second joining portion 46 at the end face of the electrode laminates 12, 14 in the Y-direction (i.e., the end face in a +Y direction or the end face in a −Y direction). In this case as well, it is appropriate that the binding portion 42 make a loop around the two electrode laminates 12, 14.

In the above embodiment, the separators 40 of the two adjacent electrode laminates 12, 14 are directly adjacent to each other. In other embodiments, the electrode sheet 20, 30 may be disposed on the end face of the second electrode laminate 14, and the separator 40 of the first electrode laminate 12 may be interposed between the two adjacent electrode laminates 12, 14.

In the above embodiment, the binding portion 42 is provided integrally with the separator 40 of the first electrode laminate 12. In other embodiments, the binding portion 42 may be provided integrally with the separator 40 of the second electrode laminate 14.

In the above embodiment, the electrode assembly 10 includes the two electrode laminates 12, 14. However, the electrode assembly 10 may include three or more electrode laminates stacked along the Z-direction. That is, the electrode assembly 10 only needs to include at least two electrode laminates 12, 14. In this case, it is appropriate that the electrode laminate located at the end in the Z-direction have the binding portion 42. It is appropriate that, in any two adjacent electrode laminates, the distance between the centers of gravity in the X-direction be equal to or less than the predetermined reference value and the distance between the centers of gravity in the Y-direction be equal to or less than the predetermined reference value. It is also appropriate that the separators 40 of any two adjacent electrode laminates be joined to each other.

Although the specific examples have been described in detail above, these are merely examples and do not limit the scope of the claims. The technology described in the claims includes various modifications and variations of the specific examples illustrated above. The technical elements described in the present specification or the drawings exhibit technical utility either alone or in combination.

What is claimed is:

1. An electrode assembly comprising a plurality of electrode laminates stacked along a first direction, wherein:
each of the electrode laminates includes
a plurality of electrode sheets stacked along the first direction, and
a long separator extending in a zigzag pattern between the electrode sheets; and
a binding portion that surrounds the electrode laminates together is provided integrally with the separator of one of the electrode laminates.

2. The electrode assembly according to claim 1, wherein, in two adjacent electrode laminates out of the plurality of electrode laminates, a distance between centers of gravity in a second direction orthogonal to the first direction is equal to or less than a predetermined reference value.

3. The electrode assembly according to claim 1, wherein the separators of two adjacent electrode laminates out of the plurality of electrode laminates are joined to each other.

4. The electrode assembly according to claim 1, wherein the binding portion provided integrally with the separator makes at least one loop around the electrode laminates, and a tip of the binding portion is joined to the binding portion.

5. The electrode assembly according to claim 1, wherein the separators of two adjacent electrode laminates out of the plurality of electrode laminates are directly adjacent to each other.
